(19) United States
(12) Patent Application Publication
(10) Pub. No.: US 2022/0132744 A1
(43) Pub. Date: May 5, 2022

(54) PRUNING DEVICE

(71) Applicant: Turatti S.R.L., Cavarzere (VE) (IT)

(72) Inventor: Antonio TURATTI, Cavarzere (VE) (IT)

(73) Assignee: Turatti S.R.L., Cavarzere (VE) (IT)

(21) Appl. No.: 17/434,769

(22) PCT Filed: Feb. 27, 2020
(86) PCT No.: PCT/IT2020/050043

§ 371 Date: Aug. 30, 2021

(30) Foreign Application Priority Data
Feb. 28, 2019 (IT) 102019000002933

(51) Int. Cl. A01G 3/08; B02C 18/14; B02C 23/26

(52) U.S. Cl. CPC A01G 3/08; B02C 23/26; B02C 18/145

(57) ABSTRACT

The invention relates to a device for pruning leaves and/or other undesirable elements from the inflorescences of aromatic plants and/or from vegetable material, comprising a frame, a container and at least one removing element for removing leaves and/or other undesirable elements. The container can contain the vegetable material to be treated and comprising through-openings or slots on its surface, said at least one removing element being located so that it skims said openings or slots in correspondence with at least a portion of the surface of said container, characterized in that said at least one removing element comprises a brush.

Another object of the invention is a treatment line for aromatic plants and/or plant material comprising a pruning device of the described type.

The present invention relates to a device for pruning leaves and/or other undesirable elements on the inflorescences of certain plants, fresh or dried, which is also called a trimmer.

In particular, the invention relates to a trimmer typically used for removing leaves or other undesired parts from the inflorescences of aromatic plants and/or plant material in general, for example plants from the Cannabaceae family.

Currently the solutions already known and available in the market include a container, equipped on the lateral surface with openings of smaller dimensions than those of the inflorescences, in which the material to be treated can be inserted, surrounded externally by one or more cutting profiles that skim this side surface, such as blades.

By means of the relative rotation between the container and the cutting profiles, manually or electrically operated, the undesirable parts come out of the side wall of the container, through the special openings made in it, being separated from the inflorescences and collected in a further compartment of the machine.

These devices have a main drawback, due to the presence of resinous and/or oily substances in the material to be treated, which over time inevitably settles on the surface of the blades during the operation, making frequent and repeated cleaning operations of the residues accumulated by part of the operators, with a consequent reduction in the quantity, but also in the quality, of the finished product.

These resinous and/or oily substances, in fact, cause a progressive worsening of the capability that the cutting profiles have to separate the undesired parts from the inflorescences, selectively and without damaging the latter.

Further typical disadvantages of these machines are the low capacity of the containers, which can necessarily increase only at the expense of the mixing capacity of the material contained in them: in fact, large containers, and therefore capacious, may involve complications in ensuring an adequate mixing of the contents, risking to worsen the quality of the final product, due to the partial removal of leaves from inflorescences that do not come into contact with the blades.

Another disadvantage is given by the poor accessibility to all the elements of the machine, during the loading, unloading and maintenance phases.

In light of the above, the need to have a solution such as that proposed according to the present invention is apparent, which allows to solve the aforementioned problems, ensuring high production volumes together with simpler and more sporadic maintenance phases.

Therefore, object of the invention is a device for pruning leaves and/or other undesirable elements from the inflorescences of aromatic plants and/or plant material, which includes a frame, a container and at least one removal element for removing these elements.

In particular, the container is used to contain the vegetable material to be treated and has through openings, or slots, obtained on its surface.

Advantageously, the removal element is positioned so as to skim the openings, or slots, in correspondence of least a portion of the surface of the container.

Advantageously, the removal element comprises a brush, so as to increase the efficiency of the pruning process; in fact, on the brushes, compared to traditional blades, a smaller quantity of oily and/or resinous residues accumulates during the operation of the device.

In this way, the frequent and repeated cleaning operations of the residues accumulated on the removal elements can be reduced.

Furthermore, the pruning device can provide a support, integral with the container, and configured to allow the container itself to pass from an engaged position, when the device is in use, to an unengaged position, when the device is not in use; this eases the access to the brushes during cleaning.

In addition, this pruning device can comprise a fan, configured to develop a depression in a first zone, located in an intermediate position between the fan itself and the container; in this way the leaves of the inflorescences come out through the openings or slots, in correspondence at least of the portion of the surface of the container.

In this way, advantageously, the leaves are removed from the brushes.

Possibly, the pruning device may contain an openable panel for fan maintenance.

In a further preferred variant of the device at issue, the unengaged position can correspond to a raised position with respect to the frame.

This is to advantageously allow to maximize the accessibility to the brushes and, at the same time, simplify the device construction operations.

More particularly, the support can be rotatably fixed to the frame, for further construction simplicity.

Finally, a further object of the invention is a treatment line for inflorescences of aromatic plants comprising a device according to the invention.

Such treatment line is particularly efficient since it combines the advantages of the device already described.

The present invention will be now described, for illustrative but not limitative purposes, according to its preferred embodiments, with particular reference to the figures of the enclosed drawings, wherein:

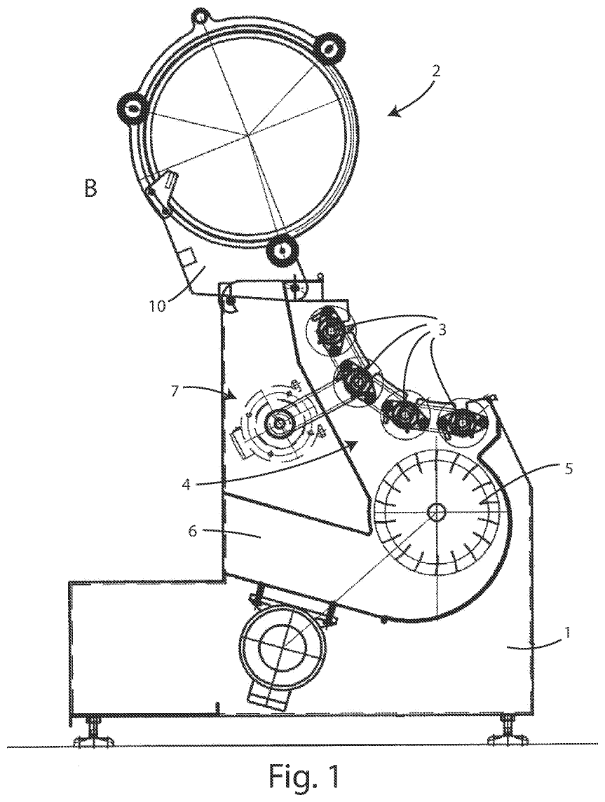

FIG. 1 is a cross section of the trimmer according to the invention with the container in a raised position;

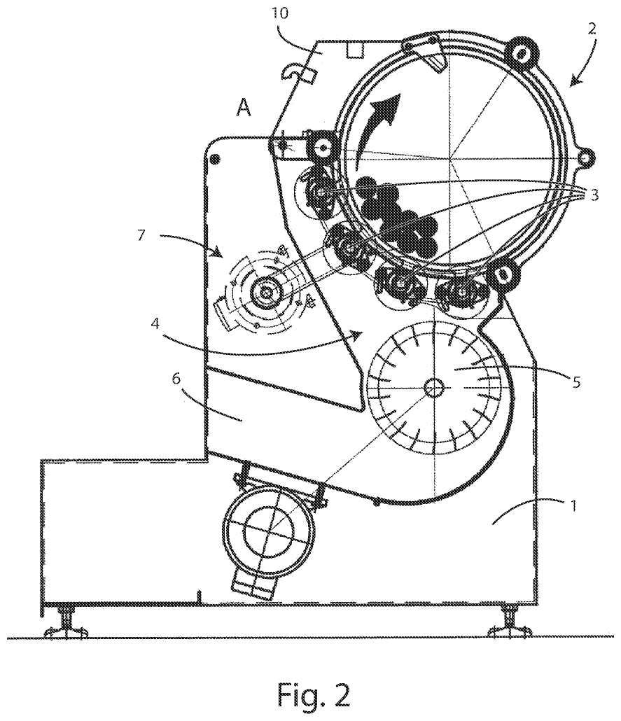

FIG. 2 is a cross section of the trimmer according to the invention with the container in an operating position;

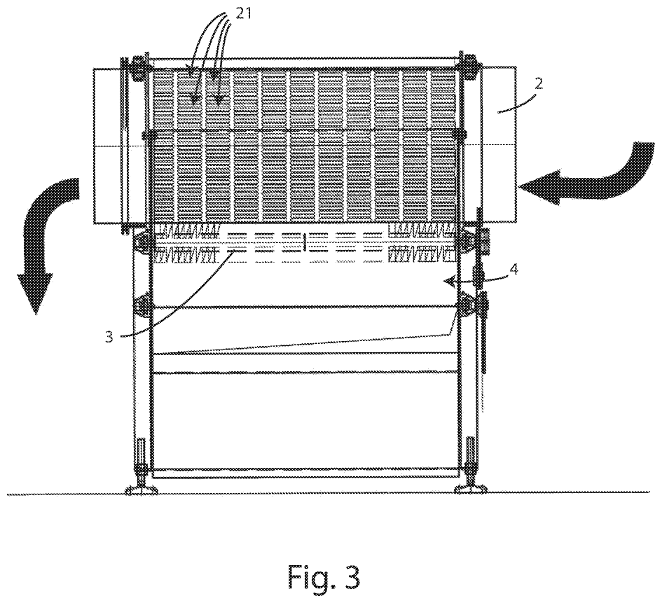

FIG. 3 is a longitudinal section of the trimmer according to the invention.

Initially observing FIGS. 1, 2 and 3, the invention at issue therefore aims to overcome the drawbacks already described, in particular by means of a container 2 mounted on a lifting support 10, which allows easy access to cutting elements 3 during maintenance; said cutting elements 3 advantageously include brushes. Such brushes, in fact, are less subject to deterioration deriving from the accumulation of resinous and/or oily residues on their surface compared to traditional cutting elements, in particular to the blades.

In particular, the lifting support 10 is hinged above the frame 1 and rigidly fixed, possibly reversibly, to the container 2, allowing it to pass from the lowered position A, or operating position, to the raised position S, or maintenance position, and vice versa.

Advantageously, thanks to the presence of the lifting support 10, it is also possible to provide for the use of traditional blades as an alternative to the brushes.

More in detail, the trimmer according to the invention comprises a frame 1, with containment and support functions, resting on a reference surface (floors, etc. . . . ), together with a plurality of components housed inside it.

Among them there are at least a rotating container 2, preferably a drum, made for example of stainless steel, preferably having a diameter of about 500 mm, on the surface of which a plurality of openings or slots 21 are advantageously obtained (which can be seen in FIG. 3), one or more cutting elements 3, preferably of the brushes, arranged along one or more directions, substantially parallel to the axis of rotation of the container 2 and which surround it, at least partially, by touching its external surface. The tips of the bristles of the brushes are located at a reduced or zero distance from the external surface of the container, close to first zone 4 of the frame 1, in which a depression is created, which attracts the leaves or other unwanted parts of the inflorescences of the plants, from inside the container 2, through the slots 21, towards the bristles themselves of the brushes 3. Within the frame 1, in a position lower than the first zone 4, or suction zone, a fan 5 is incorporated, which conveys an airflow through the container 2 and towards a second delivery zone 6.

This suction zone 4 substantially corresponds to an intermediate compartment located between the container 2 and the fan 5, near the brushes 3; during operation of the device, the fan 5 creates a depression in the suction zone 4, in correspondence of the portion of the external surface of the container 2 close to the brushes 3, pushing the leaves present on the inflorescences through the openings 21.

Inside the frame 1 there are also a first motor (not shown), which rotates the container 2, a second motor (not shown), which rotates the fan 5, and, if necessary, a third motor 7 (which can be seen in FIGS. 1 and 2), which can rotate the cutting elements 3 completely and independently.

It is also foreseeable the installation, inside the device itself or in a connected housing, of speed variators (not shown) for the motor control, for example of the VFD (Variable-Frequency-Drive) type.

Operatively, in a preliminary phase of preparation of the operating cycle of the machine, a suitable quantity of plant material to be treated is positioned within the container 2.

Once activated, the device removes the leaves and/or other undesired elements present on the inflorescences by means of the brushes 3 and the air flow generated by the fan 5; this flow, passing through the container 2, attracts the material to be treated towards the wall thereof, in correspondence with the suction zone 4 and recollects its leaves, which advantageously come out through the slots 21; at this point the brushes 3 tear off the leaves, which are conveyed, through the same fan 5, to the delivery zone 6.

Optionally, in a third zone, downstream from the delivery zone 6, it is possible to house a container (not shown), in which the leaves following their separation can be received, and/or a filtering system for the air to be expelled.

The installation, in the delivery zone 6, of a magnet or iron remover (not shown in the figure) may also be provided, with the aim of retaining any fragments of the brushes 3, conveniently manufactured in magnetic stainless steel, which may have come off and therefore be ended with the removed leaves.

Advantageously, the slots 21 are arranged along the entire surface of the container 2, and have a width such as to allow only the leaves of the aromatic plants to pass, retaining the inflorescences; this width can therefore be, depending on the plant species of interest, between 4 mm and 10 mm, and preferably 7 mm, such as to maximize the effectiveness of the process, without risking damaging the flower and removing some portions together with the leaves.

Preferably, during the operation of the trimmer, the container 2 continuously rotates, to allow the continuous mixing by gravity of the material contained therein.

In particular, the simultaneous adjustment of the operating parameters, such as the rotation speed of the container 2 and/or the flow of the air sucked by the fan 5, allows to obtain an adequate cleaning of the plant material to be treated.

As can be imagined, in fact, a reduced rotation speed of the container, or an excessive airflow, would not allow the inflorescences to roll transversely along the wall of the container, and therefore to mix homogeneously.

Vice versa, with an excessive rotation speed of the container, or with an insufficient airflow, the inflorescences would bring to adhere to the wall, due to the centrifugal force. In both cases, a suboptimal cleaning of the product would be obtained.

Once the machine's operating cycle is completed, preferably after about 5-10 minutes depending on the quantity of product to be treated and the desired degree of cleaning, the trimmer is stopped, the container 2 can be emptied of the processed product, which it has been stripped of leaves and/or other undesired parts.

If it is necessary to clean the brushes, or the blades, from the resinous residues that have accumulated, the machine can be stopped, even during its operation: advantageously, the container 2 can be lifted by means of a support 10, manually or automatically, passing to the maintenance configuration (which can be seen in FIG. 1).

The brushes 3, or the blades, are then easily exposed and made available for being cleaned, by an operator or automatically.

In addition, also the portion of the frame 1, which protects the fan 5 can be tipped, to allow cleaning thereof from the residues deriving from the passage of the leaves on the blades.

A further advantage of the described solution is that it can be installed in an industrial-scale production plant, which comprises, in addition to the device at issue, machines used for carrying out other operations on the product.

These machines could be connected in order to carry out both subsequent and previous the pruning operations, thus creating a production line for the treatment of vegetable materials.

For example, the device at issue could be inserted in a working station following that for the separation of the inflorescences from the branches of the aromatic plants: these inflorescences, after being accumulated in sufficient quantity for the pruning treatment, can be dosed and subjected to the treatment.

Subsequently, an inflorescence selection station may be present, based on the size and appearance, followed by treatment in a dryer and/or in an extractor of aromatic essences, obtaining a complete treatment cycle of the product.

Another peculiarity of the pruning device, when used in this context on an industrial scale, is that of being able to arrange and connect in series two or more devices, for example through inclined slides; in this way, the plant material coming out from the first is transferred consecutively to the following ones, in an uninterrupted flow configuration that perfectly adapts to the needs of an continuous operation industrial system thus conceived.

The present invention has been described, for illustrative but not limitative purposes, according to its preferred embodiments, but it is to be understood that variations and/or modifications may be made by those skilled in the art, without thereby departing from the relative scope of protection.

1. Device for pruning leaves and/or other undesirable elements from the inflorescences of aromatic plants and/or from vegetable material, comprising a frame (1), a container (2) and at least one removing element (3) for removing leaves and/or other undesirable elements, said container (2) being suitable to contain the vegetable material to be treated and comprising through-openings or slots (21) on its surface, said at least one removing element (3) being located so that it skims said openings or slots (21) in correspondence with at least a portion of the surface of said container (2), characterized in that said at least one removing element (3) comprises a brush.

2. Device for pruning according to claim 1, characterized in comprising a support (10) which is integral to said container (2) and configured to allow said container (2) to switch from an engaged position (A), wherein said device is in exercise, to an unengaged position (B), wherein said device is not in exercise.

3. Device for pruning according to claim 2, characterized in that said unengaged position (B) corresponds to a lifted up position in relation to said frame (1).

4. Device for pruning, according to claim 2, characterized in that said support (10) is pivotably fixed to said frame (1).

5. Device for pruning according to claim 1, characterized in comprising a fan (5) configured to create a depression in a zone (4), which is located in an intermediate position between said fan (5) and said container (2), in order to force the leaves to come out through said openings or slots (21), in correspondence to at least said portion of the surface of said container (2).

6. Device for pruning according to claim 5, characterized in comprising an openable panel for the fan (5) maintenance.

7. Treating line for aromatic plants and/or vegetable material characterized in comprising a device according to claim 1.

8. Device for pruning, according to claim 3, characterized in that said support (10) is pivotably fixed to said frame (1).

9. Device for pruning according to claim 2, characterized in comprising a fan (5) configured to create a depression in a zone (4), which is located in an intermediate position between said fan (5) and said container (2), in order to force the leaves to come out through said openings or slots (21), in correspondence to at least said portion of the surface of said container (2).

10. Device for pruning according to claim 3, characterized in comprising a fan (5) configured to create a depression in a zone (4), which is located in an intermediate position between said fan (5) and said container (2), in order to force the leaves to come out through said openings or slots (21), in correspondence to at least said portion of the surface of said container (2).

11. Device for pruning according to claim 4, characterized in comprising a fan (5) configured to create a depression in a zone (4), which is located in an intermediate position between said fan (5) and said container (2), in order to force the leaves to come out through said openings or slots (21), in correspondence to at least said portion of the surface of said container (2).

12. Treating line for aromatic plants and/or vegetable material characterized in comprising a device according to claim 2.

13. Treating line for aromatic plants and/or vegetable material characterized in comprising a device according to claim 3.

14. Treating line for aromatic plants and/or vegetable material characterized in comprising a device according to claim 4.

15. Treating line for aromatic plants and/or vegetable material characterized in comprising a device according to claim 5.

16. Treating line for aromatic plants and/or vegetable material characterized in comprising a device according to claim 6.
